(19) United States
(12) Patent Application Publication
(10) Pub. No.: US 2017/0277512 A1
(43) Pub. Date: Sep. 28, 2017

(54) INFORMATION OUTPUT APPARATUS

(71) Applicant: YAZAKI CORPORATION, Tokyo (JP)

(72) Inventors: Takashi Shiota, Shizuoka (JP); Yukio Suzuki, Shizuoka (JP)

(21) Appl. No.: 15/434,892

(22) Filed: Feb. 16, 2017

(30) Foreign Application Priority Data
Mar. 24, 2016 (JP) 2016-060336

(51) Int. Cl. G06F 3/16; G10L 21/055; G06F 3/01

(52) U.S. Cl. CPC G06F 3/167; G06F 3/013; G10L 21/055

(57) ABSTRACT

With occurrence of an event as a trigger, outputting a notification sound of auditory information is started. Start of a character guide of visual information is delayed relatively to a timing of the trigger so as to be synchronized with start of a voice guide of auditory information. A user is surely made aware of a schedule of the start of the guides by the output of the notification sound. After the user moves his/her eyes to a screen for the character guide, the character guide and the voice guide are executed. Since no time lag is generated between the character guide and the voice guide, it is possible to prevent occurrence of a sense of incompatibility.

### CROSS REFERENCE TO RELATED APPLICATIONS

This application is based on and claims priority from Japanese patent application No. 2016-060336 filed on Mar. 24, 2016, the entire contents of which are incorporated herein by reference.

### BACKGROUND OF THE INVENTION

1. Technical Field

The present invention relates to an information output apparatus which has a sound output portion and a display portion.

2. Background Art

When, for example, occurrence of some event is detected on a vehicle, an acoustic sound may be outputted or information of characters etc. may be outputted on a screen of a display device in order to inform a driver of the situation or to show the driver contents of a necessary driving operation or a necessary operation on an in-vehicle device. In addition, in some cases, both the output of the acoustic sound and the screen display may be used together.

Patent Literature JP-A-2009-42843 discloses a warning device which outputs a warning sound to draw driver's attention to an object which has been detected in the vicinity of a driver's own vehicle. In addition, in Patent Literature JP-A-2009-42843, a marker sound for giving previous notice that the warning sound will be outputted is outputted previous to outputting the warning sound, in order to draw the driver's attention in the driver's own vehicle. Here, the marker sound is a relatively short sound like “pong”, “poon” or “beep”. The warning sound is a long continuing sound like “boon . . . ”. Moreover, since the warning sound continues long, a localization state of the sound can be controlled to be consistent with a direction of the object such as another vehicle in accordance with movement of the object.

That is, the marker sound is outputted previous to outputting the warning sound. Accordingly, due to the driver's perception of the marker sound, the driver can be easily aware that noteworthy information will be succeedingly outputted as the warning sound. Thus, it is possible to prevent the driver from missing to hear the warning sound. As a result, it is possible to transmit the information effectively.

In addition, Patent Literature JP-A-H11-145955 discloses an information distributing system in which character data, sound data, or sound data corresponding to character data can be downloaded selectively. In addition, Patent Literature JP-A-H11-145955 discloses that, in the case where distribution information to be outputted is constituted by both sound information and character information, a sound output serving as the sound information is executed at a timing synchronized with a character output serving as the character information, or the character output serving as the character information is executed at a timing synchronized with the sound output serving as the sound information.

### SUMMARY

When, for example, some event has occurred on a vehicle, there is a possibility that a driver may be guided by a voice output. Moreover, the driver may notice the guide after a certain time has elapsed since the start of the guide. In this case, there is a possibility that the driver may miss to hear an initial part of the guide. In order to prevent such a problem, it may be supposed that control is made to output a short notification sound like “pong” or “beep” etc. previous to starting outputting the voice guide in the same manner as the technique of Patent Literature JP-A-2009-42843 so that the driver can be made aware that the voice guide will be outputted following the notification sound. Further, it may be also supposed that contents of the voice guide or reference information relevant to the voice guide is used together with the voice guide and displayed on a predetermined display screen using characters etc.

In the aforementioned situation, the sound output and the screen display are usually started with the occurrence of the event as a trigger. Accordingly, the character information for the guide is displayed on the screen at the same timing as the output start of the notification sound.

However, it has been proven by an experiment that the driver tends to feel a sense of incompatibility when control is made in the aforementioned manner. That is, it is considered that the driver first notices the screen display due to the notification sound, and then perceives auditory information based on the voice guide in a state in which the auditory information is delayed relatively to the visual information of the screen display. Therefore, the driver feels a sense of incompatibility about a time lag between the visual information and the auditory information.

The invention has been accomplished in consideration of the aforementioned circumstances. An object of the invention is to provide an information output apparatus which can suppress a sense of incompatibility felt by a user such as a driver and optimize a guide in the case where both an output of a notification sound and a voice guide are used in combination and screen display using characters is further used together when information for the guide is outputted.

In order to achieve the foregoing object, the information output apparatus according to the invention is characterized in the following paragraphs (1) to (4).

(1) An information output apparatus including:

a sound output portion which outputs auditory information in response to occurrence of a predetermined event; and

a display portion which outputs visual information in response to the occurrence of the predetermined event; wherein:

the sound output portion outputs a voice guide, and a notification sound which is notified previous to outputting the voice guide; and

the display portion starts outputting a character guide in synchronization with a timing at which the output of the voice guide is started by the sound output portion, the character guide being constituted by characters associated with information presented by the voice guide.

(2) An information output apparatus according to the aforementioned paragraph (1), wherein:

the information output apparatus is mounted in a vehicle, and the display portion is installed in a position which can be visually recognized by a driver; and

a time between start of the output of the notification sound and the start of the output of the voice guide and the character guide is determined based on a time which is required for the driver to move his/her eyes from a front of the vehicle to the display portion after the driver recognizes the notification sound,

(3) An information output apparatus according to the aforementioned paragraph (1), wherein:

a time between termination of the output of the notification sound and the start of the output of the voice guide and the character guide is restricted to be not longer than a predetermined time,

(4) An information output apparatus according to the aforementioned paragraph (1), wherein:

a time between start of the output of the notification sound and the start of the output of the voice guide and the character guide is restricted to be not longer than a predetermined time.

According to the information output apparatus having the configuration according to the aforementioned paragraph (1), a timing for starting outputting the voice guide outputted by the sound output portion and a timing for starting outputting the character guide outputted by the display portion are synchronized with each other. Accordingly, it is possible to eliminate a time lag between the visual information and the auditory information, which can be perceived by a user such as the driver, so that it is possible to prevent occurrence of a sense of incompatibility, In addition, the notification sound is outputted previous to starting outputting the voice guide and the character guide. Accordingly, the user such as the driver is easily aware that the voice guide and the character guide will be outputted so that information can be transmitted surely from the apparatus to the human being, It is also possible to avoid a recognition delay of the voice guide and the character guide.

According to the information output apparatus having the configuration according to the aforementioned paragraph (2), outputting the voice guide and the character guide can be started with reference to a time when the user such as the driver moves his/her eyes to the display portion in reaction to recognition of the notification sound. Accordingly, outputting the voice guide and the character guide can be started at a timing the user can feel just right. That is, the user never feels the output start of the voice guide and the character guide either too early or too late.

According to the information output apparatus having the configuration according to the paragraph (3), an upper limit of a time length of an unchanged state between when the notification sound stops ringing and when there appears a change in the voice guide and the character guide is restricted. Accordingly, it is possible to avoid a situation that the user may feel that outputting the voice guide and the character guide is late.

According to the information output apparatus having the configuration according to the aforementioned paragraph (4), an upper limit of a time length between when the user is aware of the notification sound and when outputting the voice guide and the character guide is started is restricted. Accordingly, it is possible to avoid a situation that the user may feel that outputting the voice guide and the character guide is late.

According to the information output apparatus according to the invention, it is possible to suppress a sense of incompatibility felt by a user such as a driver and optimize a guide in the case where both an output of a notification sound and a voice guide are used in combination and screen display using characters is further used together when information for the guide is outputted.

The invention has been described above briefly. Further, when an undermentioned mode (hereinafter referred to as “embodiment”) for carrying out the invention is read through with reference to the accompanying drawings, details of the invention can be made further clear.

### BRIEF DESCRIPTION OF THE DRAWINGS

FIG. 1 is a block diagram showing a configuration example of an information output system in an embodiment of the invention.

FIG. 2 is a flow chart showing a guide control example (1) in a guide control portion shown in FIG. 1.

FIG. 3 is a flow chart showing a guide control example (2) in the guide control portion shown in FIG. 1.

FIG. 4 is a time chart showing an operating example of the information output system shown in FIG. 1.

FIG. 5 is a graph showing evaluation results of two control patterns for comparison.

FIG. 6 is a graph showing evaluation results in accordance with differences in image display timing.

### DETAILED DESCRIPTION OF EMBODIMENTS

A specific embodiment as to the present invention will be described below with reference to the respective drawings.

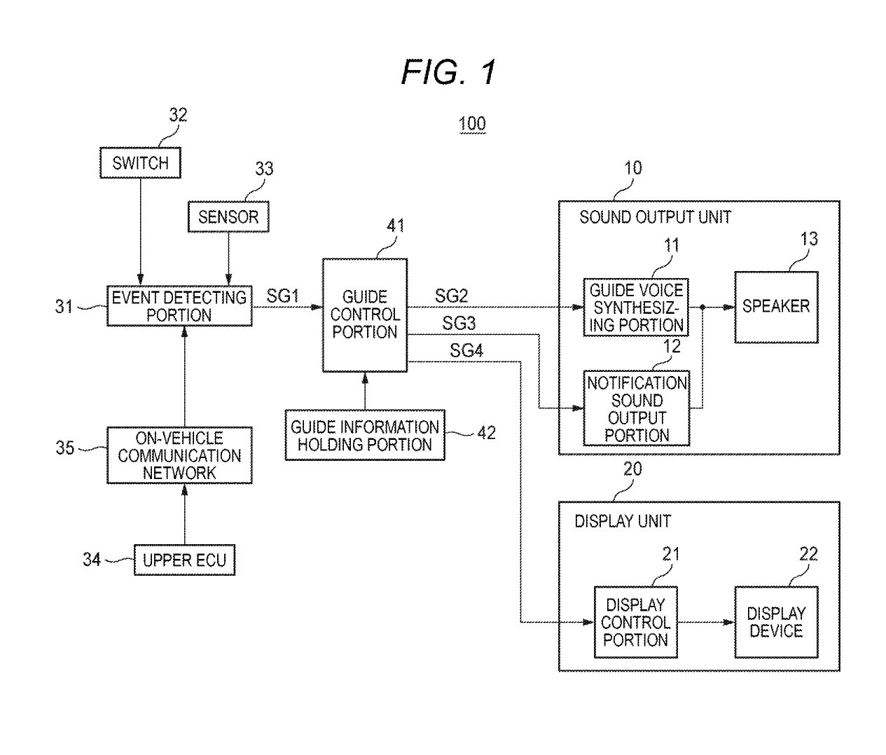

First, a configuration example of an apparatus will be described. A configuration example of an information output system 100 in an embodiment of the invention is shown in FIG. 1. The information output system 100 shown in FIG. 1 is configured on the assumption that it is used when mounted in a vehicle, Incidentally, the information output apparatus according to the invention is not limited to the in-vehicle information output system 100 shown in FIG. 1 but may be used in various applications.

The information output system 100 shown in FIG. 1 comprises a sound output unit 10, a display unit 20, an event detecting portion 31, a switch 32, a sensor 33, an upper ECU (Electronic Control Unit) 34, an on-vehicle communication network 35, a guide control portion 41, and a guide information holding portion 42.

In addition, the sound output unit 10 comprises a guide voice synthesizing portion 11, a notification sound output portion 12, and a speaker 13. The guide voice synthesizing portion 11 can generate a signal of a pseudo voice waveform similar to human voice, and output the electric signal. The electric signal is converted into an acoustic sound similar to voice and outputted by the speaker 13. Various information expressing contents which should be guided is given to the guide voice synthesizing portion 11 using a signal SG2. Thus, various synthesized voices for guiding a driver can be outputted from the guide voice synthesizing portion 11.

The notification sound output portion 12 can output an electric signal of a notification sound, which is useful for making the driver aware of an incoming guide schedule of the apparatus in an early stage. The electric signal of the notification sound is converted into an acoustic sound, which is outputted by the speaker 13. For example, the notification sound is a monotonous sound which is outputted with only a relatively short length, such as “beep” or “pang”. An output start and an output end of the notification sound are controlled by a signal SG3 inputted from the outside.

The display unit 20 is provided with a display control portion 21 and a display device 22. The display device 22 is constituted by a liquid crystal display device etc. which is provided with a display screen capable of displaying various character information. The display control portion 21 makes control to display various character information included in a signal SG4 inputted from the outside, on the display screen of the display device 22. A timing for updating display contents of the display screen is controlled by the signal SG4. The screen of the display device 22 is installed in a position which can be visually recognized by the driver easily, such as inside a center console of a cabin, inside an instrument panel or on a dash board.

It is supposed that functions of the event detecting portion 31, the guide control portion 41, the guide information holding portion 42, etc. shown in FIG. 1 are achieved, for example, by a combination of hardware such as a microcomputer and software which can be executed by the hardware. It is a matter of course that these functions may be alternatively constituted by only dedicated hardware such as a special logic circuit.

The event detecting portion 31 has a function for detecting presence/absence of occurrence of any events indicating various situations in which the driver has to be guided, and a function for detecting a kind of the event which has occurred. In the information output system 100 shown in FIG. 1, the switch 32 and the sensor 33 are connected to an input of the event detecting portion 31. In addition, the upper ECU 34 is connected to the input of the event detecting portion 31 through the on-vehicle communication network 35. Incidentally, a plurality of switches 32 or a plurality of sensors 33 may be connected to the input of the event detecting portion 31 alternatively.

The switch 32 is used for accepting an input operation from a user such as the driver, or for detecting changeover among states of various devices mounted on the vehicle. The sensor 33 is used for detecting various events on the vehicle. The upper ECU 34 grasps operating states of the various devices mounted on the vehicle or states detected by the devices respectively, and transmits the pieces of information if occasions demand.

That is, based on a signal inputted from the switch 32, a signal inputted from the sensor 33, a signal received from the upper ECU 34, etc., the event detecting portion 31 identifies presence/absence of occurrence of an event for which the driver should be guided, and specifies a kind of the event. Presence/absence of the event and the kind of the event are outputted as a signal SG1.

The guide information holding portion 42 is a non-volatile storage device which holds information required for a guide which has been determined in advance for each of the various events, The information held by the guide information holding portion 42 includes contents of voice synthesized by the guide voice synthesizing portion 11, or character information displayed on the screen of the display device 22 by the display control portion 21.

When the event detecting portion 31 detects occurrence of an event, the guide control portion 41 specifies a kind of the event based on a signal SG1 and acquires guide information associated with the event from the guide information holding portion 42. The guide control portion 41 uses signals SG2, SG3 and SG4 to control the sound output unit 10 and the display unit 20 so as to output the guide information. Specific control contents will be described as follows.

### <Guide Control Example (1)>

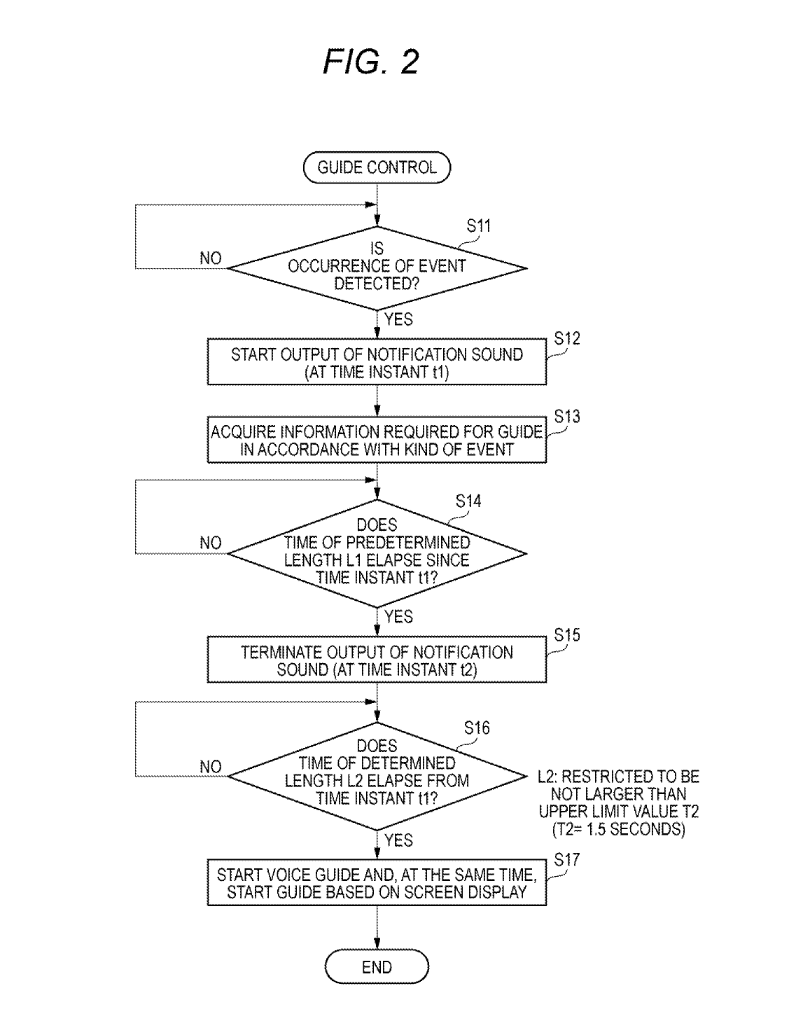

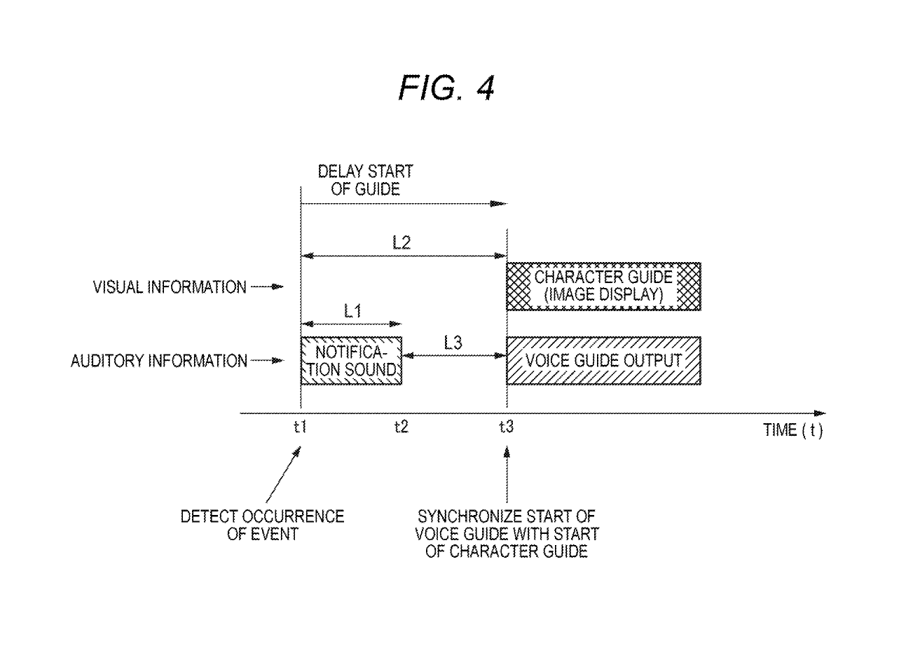

A specific example (1) of guide control in the guide control portion 41 shown in FIG. 1 is shown in FIG. 2. When the guide control portion 41 executes the guide control in FIG. 2, control of operation timings shown in FIG. 4 is implemented.

Upon detection of occurrence of an event based on an inputted signal SG1, the guide control portion 41 goes from a step S11 to a step S12. In the step S12, the guide control portion 41 controls a signal SG3 to start an output of a notification sound (at a time instant t1).

In a next step S13, based on a kind of the event specified based on the signal SG1, the guide control portion 41 acquires guide information corresponding to the event from the guide information holding portion 42. The guide control portion 41 stands by in a step S14 until a time of a predetermined length L1 elapses since the time instant t1 When the time of the predetermined length L1 elapses since the time instant t1, the guide control portion 41 controls the signal SG3 to terminate the output of the notification sound in a next step S15.

Then, the guide control portion 41 stands by in a step S16 until a time of a predetermined length L2 elapses since the time instant t1. Here, L1 and L2 are set to satisfy the relation “L2>L1”. In addition, the time of the predetermined length L2 is determined based on a required time (T0) between when the user such as the driver recognizes the output start of the notification sound performed by the sound output unit 10 and when the user moves his/her eyes on the screen of the display unit 20. In addition, the time of the predetermined length L2 is restricted to be not larger than an upper limit value T2 which has been determined in advance. The upper limit value T2 is, for example, set at “1.5 seconds”.

When it comes to a time instant t3 after a lapse of the time of the predetermined length L2 since the time instant t1 the guide control portion 41 goes to a step S17 in which the guide control portion 41 controls a signal SG2 to start a voice guide performed by the guide voice synthesizing portion 11. In synchronization with the start of the voice guide, e.g. simultaneously with the start of the voice guide, the guide control portion 41 controls a signal SG4 to start a screen display guide performed by the display unit 20.

### <Guide Control Example (2)>

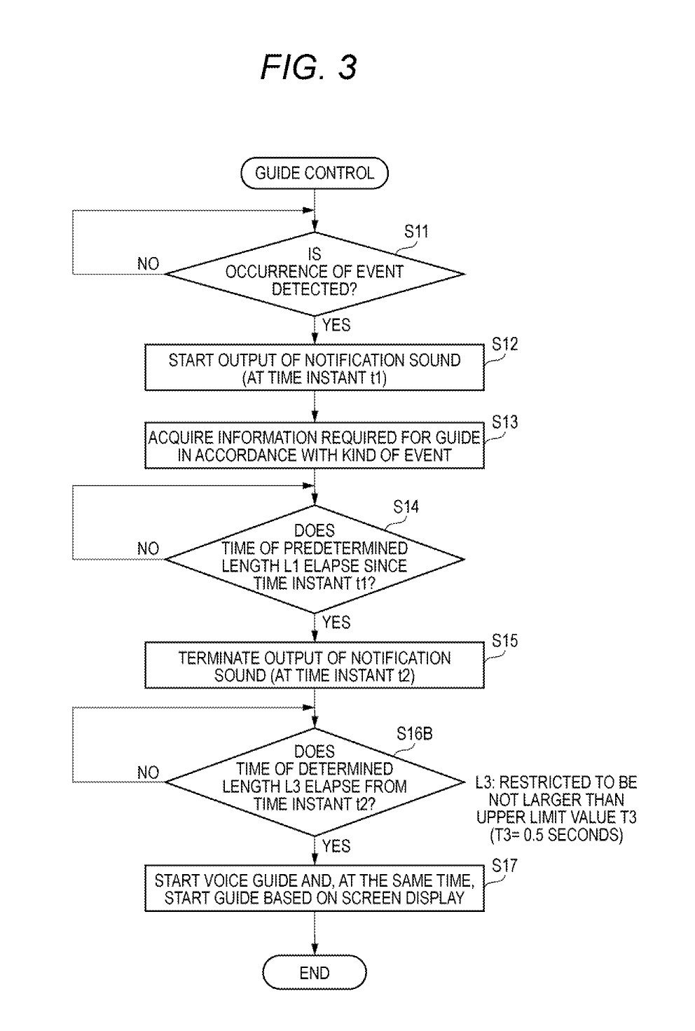

A specific example (2) of guide control in the guide control portion 41 shown in FIG. 1 is shown in FIG. 3. When the guide control portion 41 executes the guide control in FIG. 3, control of the operation timings shown in FIG. 4 is implemented. In the guide control in FIG. 3, all steps except a step S16B are the same as those in the guide control in FIG. 2.

In the step S16B the guide control portion 41 stands by until a time of a predetermined length L3 elapses since a time instant t2. Here, the time of the predetermined length L3 is controlled to be not larger than an upper limit value T3 which has been determined in advance. The upper limit value T3 is set, for example, at “0.5 seconds”.

When it comes to the time instant t3 after a lapse of the time of the predetermined length L3 since the time instant t1, the guide control portion 41 goes to a step S17 in FIG. 3 in which the guide control portion 41 controls a signal SG2 to start a voice guide performed by the guide voice synthesizing portion 11. In synchronization with the start of the voice guide, e.g. simultaneously with the start of the voice guide, the guide control portion 41 controls a signal SG4 to start a screen display guide performed by the display unit 20.

Next, the operation timings will be described by way of example.

Examples of the operation timings of the information output system 100 shown in FIG. 1 are shown in FIG. 4. When the guide control portion 41 executes the guide control shown in FIG. 2 or FIG. 3, the visual information and the auditory information synchronized with each other can be outputted, as in FIG. 4.

As to the auditory information, the output of the notification sound is started substantially simultaneously with the time instant t1 at which the occurrence of the event is detected. The notification sound is a sound for giving previous notice of an incoming voice guide to thereby make the driver aware of the voice guide. That is, since the driver is aware of the notification sound, the driver can surely recognize the incoming voice guide from the beginning so that it is possible to prevent the driver from missing to hear the voice guide.

As to the visual information, the character guide based on the screen display is started after a delay of the time of the predetermined length L2 since the time instant t1 at which the occurrence of the event is detected. In addition, the start of the character guide of the visual information is controlled to be performed at the time instant t3 substantially simultaneous with the start of the voice guide of the auditory information. That is, the character guide of the visual information and the voice guide of the auditory information are controlled to be synchronized with each other.

The output start of the visual information is delayed relatively to the time instant t1 at which the occurrence of the event is detected, as shown in FIG. 4. This is to eliminate a sense of incompatibility felt by the driver etc. Assume that, for example, outputting the visual information is started simultaneously with the time instant t1. In this case, there is a period of time in which the voice guide is not started after the driver etc, aware of the notification sound starts to visually recognize the visual information. Consequently, it is considered that the driver may have a sense of incompatibility about a time lag between the start of the character display guide and the start of the voice guide. When the output start of the visual information is delayed, the sense of incompatibility can be eliminated or lightened.

Next, evaluation results corresponding to differences of control will be described.

### <Evaluation of Differences in Control Pattern>

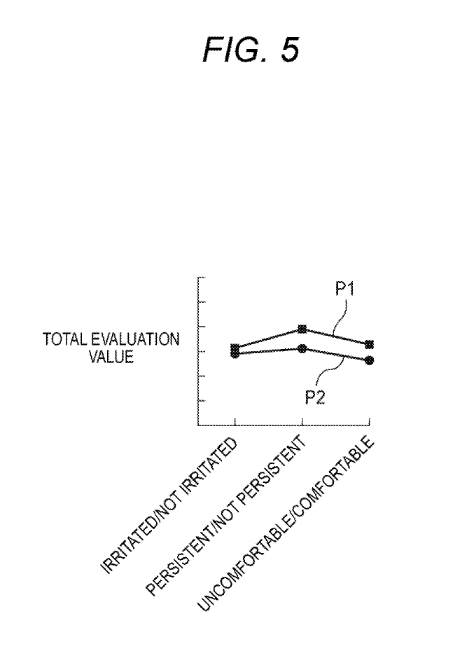

A state of comparison between evaluation results of two control patterns is shown in FIG. 5. Characteristics of the control pattern P1 shown in FIG. 5 relatively express total evaluation values (vertical axis: the larger (the upper), the better) of test subjects on three kinds of contents in a case where the character guide and the voice guide synchronized with each other were outputted at a timing delayed by a predetermined time since the output start of the notification sound as in the control shown in FIG. 4. On the other hand, characteristics of the control pattern P2 relatively express total evaluation values of the test subjects in a case where the character guide was started simultaneously with the output start of the notification sound.

According to the evaluation results of FIG. 5, when the control pattern (P1) shown in FIG. 4 is applied, it is possible to obtain an overall preferable impression in comparison with the other control pattern (P2). That is, it is possible to eliminate the sense of incompatibility felt by the user about the time lag between the start of the character display guide and the start of the voice guide.

When the delay time (L2) between the output start of the notification sound and the start of the character guide and the voice guide was large (e.g. 2 seconds or longer), a time between when a test subject moved his/her eyes to the screen and when the character guide was started was also long. It has been therefore proven that the test subject tends to feel irritated. Therefore, it is important to restrict an upper limit value of the delay time (L2).

### <Evaluation of Differences in Screen Display Timing>

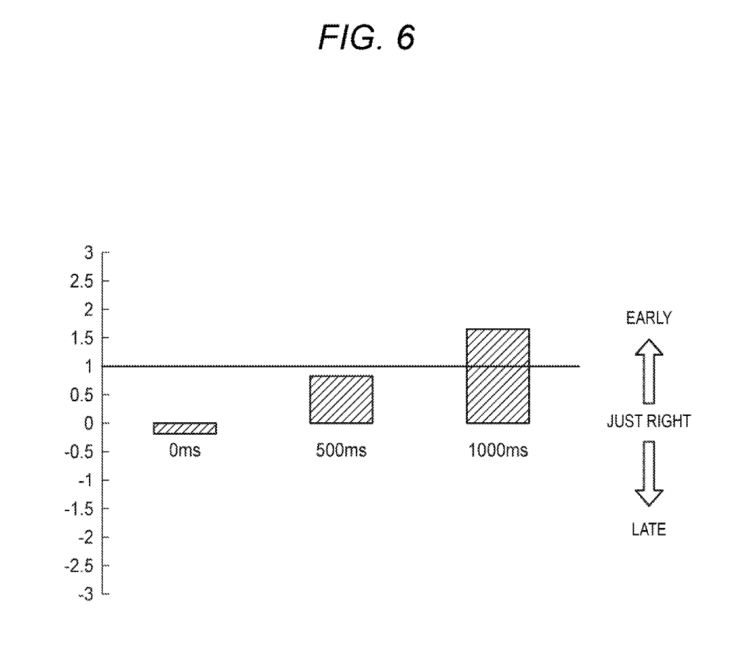

Evaluation results corresponding to differences in screen display timing are shown in FIG. 6. A vertical axis of a graph shown in FIG. 6 expresses a relative time to a timing (time instant t2) which is used as a reference (0) and at which the notification sound shown in FIG. 4 stopped ringing. The evaluation shown in FIG. 6 expresses a correlation between a difference (0 [msec], 500 [msec], 1,000 [msec]) of a time length (L3 in FIG. 4) between when the notification sound stopped ringing and when the character guide was started and evaluation felt by the test subject (early, just right, late).

According to the evaluation results in FIG. 6, it has been proven that the test subject feels “just right” when the time length (L3) is within a range of 0.5 seconds. Accordingly, the time of the predetermined length L3 is restricted to be not longer than 0.5 seconds (T3) in the guide control shown in FIG. 3, and a minimum value of the time of the predetermined length L3 is set at 0. Thus, excellent evaluation can be obtained.

In addition, although not shown in FIG. 6, it has been proven that the test subject never feel late when the time length (L2 in FIG. 4) between the timing (time instant t1) at which the notification sound shown in FIG. 4 starts ringing and the timing at which the character guide is started is within 1.5 seconds. Accordingly, when the time of the predetermined length L2 is restricted to be not longer than 1.5 seconds in the guide control shown in FIG. 2, excellent evaluation can be obtained. In addition, the minimum value of the time of the predetermined length L3 at which excellent evaluation can be obtained is “0” according to the contents of FIG. 6. Accordingly, a minimum value of the time of the predetermined length L2 at which excellent evaluation can be obtained is equal to the length (L1) of the notification sound.

In addition, it is considered that the length (time L1) of the notification sound is determined, for example, to be equal to a time which is required for the test subject to perceive the notification sound and move his/her eyes to the screen since the output start of the notification sound. Thus, control can be made so that the time between when the user moves his/her eyes to the screen in response to the notification sound and when the character guide and the voice guide are started can be just right.

Here, the aforementioned characteristics of the embodiment of the information output apparatus according to the invention are summarized briefly and listed in the following paragraphs [1] to [4] respectively.

[1] An information output apparatus (information output system 100) including:

a sound output portion (sound output unit 10) which outputs auditory information in response to occurrence of a predetermined event; and

a display portion (display unit 20) which outputs visual information in response to the occurrence of the predetermined event; wherein:

the sound output portion outputs a voice guide, and a notification sound which is notified previous to outputting the voice guide; and

the display portion starts outputting a character guide in synchronization with a timing (time instant t3) at which the output of the voice guide is started by the sound output portion, the character guide being constituted by characters associated with information presented by the voice guide (S16-S17, S16B-S17).

[2] An information output apparatus according to the aforementioned paragraph [1], wherein:

the information output apparatus is mounted in a vehicle, and the display portion is installed in a position which can be visually recognized by a driver; and

a time (L2) between start of the output of the notification sound and the start of the output of the voice guide and the character guide is determined based on a time which is required for the driver to move his/her eyes from a front of the vehicle to the display portion after the driver recognizes the notification sound.

[3] An information output apparatus according to the aforementioned paragraph [1], wherein:

a time (L3) between termination (time instant t2) of the output of the notification sound and the start (time instant t3) of the output of the voice guide and the character guide is restricted to be not longer than a predetermined time (upper limit value T3).

An information output apparatus according to the aforementioned paragraph [1], wherein:

a time between start (time instant t1) of the output of the notification sound and the start (time instant t3) of the output of the voice guide and the character guide is restricted to be not longer than a predetermined time (upper limit value T2).

What is claimed is:

1. An information output apparatus comprising:
a sound output portion which outputs auditory information in response to occurrence of a predetermined event; and
a display portion which outputs visual information in response to the occurrence of the predetermined event; wherein:
the sound output portion outputs a voice guide, and a notification sound which is notified previous to outputting the voice guide; and
the display portion starts outputting a character guide in synchronization with a timing at which the output of the voice guide is started by the sound output portion, the character guide being constituted by characters associated with information presented by the voice guide.

1. An information output apparatus according to claim 1, wherein:
the information output apparatus is mounted in a vehicle, and the display portion is installed in a position which can be visually recognized by a driver; and
a time between start of the output of the notification sound and the start of the output of the voice guide and the character guide is determined based on a time which is required for the driver to move his/her eyes from a front of the vehicle to the display portion after the driver recognizes the notification sound.

3. An information output apparatus according to claim 1, wherein:
a time between termination of the output of the notification sound and the start of the output of the voice guide and the character guide is restricted to be not longer than a predetermined time.

4. An information output apparatus according to claim 1, wherein:
a time between start of the output of the notification sound and the start of the output of the voice guide and the character guide is restricted to be not longer than a predetermined time.
